(19) United States
(12) Patent Application Publication
(10) Pub. No.: US 2012/0038179 A1
(43) Pub. Date: Feb. 16, 2012

(54) Mechanical device for securing and pulling people in peril to safety

(76) Inventor: Jose Francisco Segovia, Laredo, TX (US)

(21) Appl. No.: 12/806,507

(22) Filed: Aug. 16, 2010

(51) Int. Cl. B63C 9/00; A62B 99/00; B25J 1/00; B25B 9/00

(52) U.S. Cl. 294/19.3

(57) ABSTRACT

A life saving device having a substantially elongated body with talon-like appendages at the front end, and radially extending handles at the breech end mechanically connected to open and close appendages. It also has a locking mechanism that locks the appendages at their position until they are manually unlocked or released by activating a disengaging mechanism. The shape of the appendages along with the way they are attached to the main body vary. The angle of the appendages in relation to the axis of the body and the way they are attached to the main body will also depend on what it will be used for, whether it's helping a person struggling in the water, securing and pulling someone from the bottom of a swimming pool, or moving a container with a hazardous material to a safer place. The material it is made of will also depend on what it will be used for. Some examples are stainless steel, titanium, fiber glass or one of the strong non conductive materials available.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND-FIELD OF INVENTION

This invention relates to a device that aids a person in the process of rescuing another person by mechanically securing him and pulling him to safety.

### BACKGROUND-PRIOR ART

All swimming pools were designed and built for recreational purposes. They were made for people to have a good time. The only drawback is that every swimming pool, especially the ones with deep water, presents a danger to non-swimmers. It is advisable to swim only when there is a life guard on duty or to have someone who knows how to swim and trained in saving a person in distress close by. If this is not possible, a dangerous situation exists where both the person in distress and the person attempting the rescue can lose their lives.

Therefore, several types of devices were designed to assist a person in rescuing another individual who finds himself in a hazardous situation without exposing the rescuer to the same danger. These inventions partially solved the life threatening problem, but they leave a lot of the saving to be done by the person in peril. They all require the person in harms way to hang on to the device or to be in certain position in order to be helped by the device. It is also extremely difficult to extract a person from the water if the person has already gone underwater.

For example, U.S. Pat. No. 3,106,726 to Dwyer (1963) generally discloses an elongated tubular body with a semicircular hook on one end to encircle the waist of a human to be pulled to safety. The device also floats, therefore, can be thrown in the direction of a person in peril to keep the person afloat and be pulled to safety. The advantages of this invention are obvious, but it has its limitations. The hook is large enough for an adult person, but it is too large for a small child. It also requires for the person to be rescued to grab and hang on to the hook in certain cases. If the person has already gone underwater it would be difficult for the individual to be brought to the surface due to the inability of the person to hang on to the hook. The floating ability of the pole will assist a person in staying afloat, but the pole will be difficult to handle if it is needed to retrieve a person who has already gone underwater due to its design to stay above the water. It is also difficult to pick up an unconscious person from the bottom of a swimming pool without having the person slip away from the hook.

U.S. Pat. No. 3,330,588 to Alfano (1967) generally discloses an implement that can be used by a person to pull another individual who has come in contact with an energized electric wire to safety without exposing himself to the same danger. The implement is in the form of a pair of grasping pincers made of insulating material. It is extremely useful while working around high voltage electrical wires in very hazardous areas. Unfortunately, they are not long enough to help an individual who finds himself in trouble beyond the reach of this invention.

U.S. Pat. No. 4,580,825 to Johnson discloses an elongated grappling mechanism with both ends of the invention having grappling hooks of different sizes and shapes. The different sized grappling hooks are to be used according to the size of the person in need of help, or to grasp different parts of the individual's body. The elongated body of the invention can be extended which makes it very useful, but it also requires the person in need of assistance to hang on to it in most cases. It can move an unconscious person around at the bottom of a swimming pool, but it is very difficult to pick him up with it.

### SUMMARY OF THE INVENTION

In accordance with one embodiment, a device comprising a tubular elongated body with a set of curved talons large enough to grasp a human being at the front end. At the breech end are handles whereby people can manipulate the opening or closing of the curved talons.

### DRAWING DESCRIPTIONS

FIG. 1 shows a perspective view of the preferred embodiment.

FIG. 2 shows an exploded perspective view of the front end of the preferred embodiment.

FIG. 3A shows the side view in cross section of the front end of the preferred embodiment with the talons in the open position.

FIG. 3B shows the side view in cross section of the front end of the preferred embodiment with the talons in the closed position.

FIG. 3C shows an enlarged view in cross section of the front locking mechanism of the preferred embodiment.

FIG. 3D shows the side view in cross section of the talons in the unlocked position of the preferred embodiment.

FIG. 4A shows an exploded perspective view of the breech end of the preferred embodiment.

FIG. 4B shows the side view in cross section of the breech end of the preferred embodiment with talons in the open position.

FIG. 4C shows an enlarged view of the rear locking mechanism of the preferred embodiment.

FIG. 5 shows a similar embodiment comprising a two piece flare.

FIG. 6 shows a perspective view of an alternate embodiment.

FIG. 7A shows a side view in cross section of the rear end of an alternate embodiment.

FIG. 7B shows a side view in cross section of the front end of an alternate embodiment.

FIG. 8 shows the side view of another embodiment showing talons with a different angle.

FIG. 9 shows a side view in cross section of still another embodiment with a different way of attaching the talons to the carriage.

FIG. 10 shows a different embodiment with angular talons.

DRAWINGS-REFERENCE NUMERALS

| | |
|---|---|
| 11 body | 13A and B appendages, (talon-like) |
| 15 carriage | 17 extension, carriage |
| 16 body, breech | 18 flute, body, release latch |
| 19 fastener, talons to carriage | 21 lug, stop |
| 20 carriage hollow base | 22 sear, release latch |
| 23 spring, torsion, talons | 25 spring, coil carriage return |
| 27 retaining ring, annulus, spring | 29 latch, release when pushed |
| 31 fastener, pivot, release latch | 33 spring, coil, release latch |
| 35A and B handles multiple, body | 37A and B handles, multiple, |
| | extension |
| 36 slit, on carriage for talons | 38 slot, carriage, for sear |
| 39 locking sleeve, grooved | 41 retainer, carriage extension |
| 43 latch, locking, on handle | 45 fastener, pivot, locking latch |
| 47 spring, coil, locking latch | 49 link, strap, side view |
| 51A and B opening, pivot, talons | 53 opening, pivot, release handle |
| 55 handle, single body | 57 bevel, release sear |
| 59 slot, extension, latch sear | 61 body, single handle |
| 63 handle, extension, no locks | 65 carriage/extension, one piece |
| 67 body, angled flare | 69 flared, front, angled |
| 71A and B talons, scissor type | 73A and B opening, pivot, scissor |
| | talons |
| 75 fastener, pivot, scissor talons | 77A and B opening, talons to strap |
| | link |
| 79A and B opening, strap link to | 81A and B fastener, talon, link |
| carriage | |
| 83 fastener, strap link to carriage | 85A and B opening, strap link to |
| | talons |
| 87A and B talons, angled | 89 fastening screws, for flair cover |
| 91 opening, on carriage, to talons | 93 flanges, collar, on carriage |
| 95 flared front of body | 97 tip, conical, on carriage extension |
| 99 groove, extension, release latch | 101 cover, flair |
| 103 sear, locking latch | 105 opening, pivot, extension latch |
| 107 opening, pivot, lock latch | 109 slot, extension handle |
| 111 bevel, on locking sear | 113A and B strap link front view |
| 115 body, two piece | 117 latch, release when lifted |
| 119 body, configuous with talons | 121 breech end of carriage |
| 123 different body flare | 125 sleeve, guiding |
| 127 soft material coating talons | |

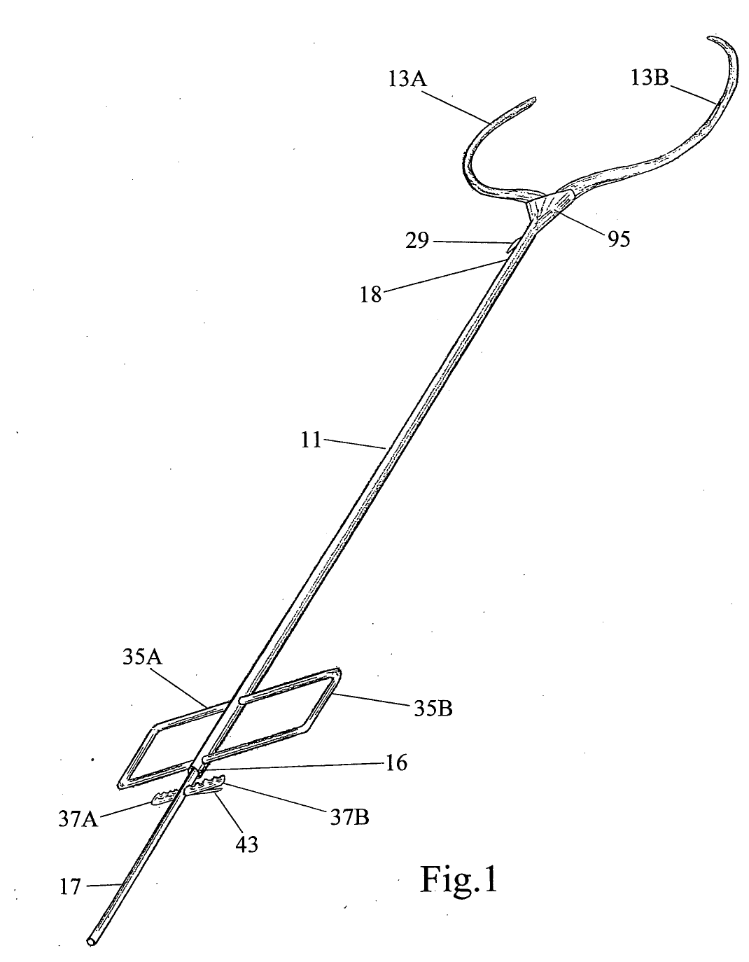

### DETAILED DESCRIPTION OF PREFERRED EMBODIMENT FIGS. 1, 2, 3A, 3B, 3C, 4A, 4B, 4C

Referring now to the accompanying drawings wherein like reference numerals refer to the same or equivalent structure, all figures illustrate embodiments of a safety rescue device which are adapted for use in extracting a person from a dangerous area.

A preferred embodiment of the invention is illustrated in FIG. 1. The device includes a generally elongated tubular body 11 having a substantially longitudinal length and a predetermined diameter which houses the moving parts of the device. The front end is flared 95 away from body 11 in opposite directions at a predetermined angle and length. It also has a flute 18 on the side to allow longitudinal movement of release latch 29. Breech end of body 16 is open with a plurality of handles attached to the side for the manipulation of the talons at the front end.

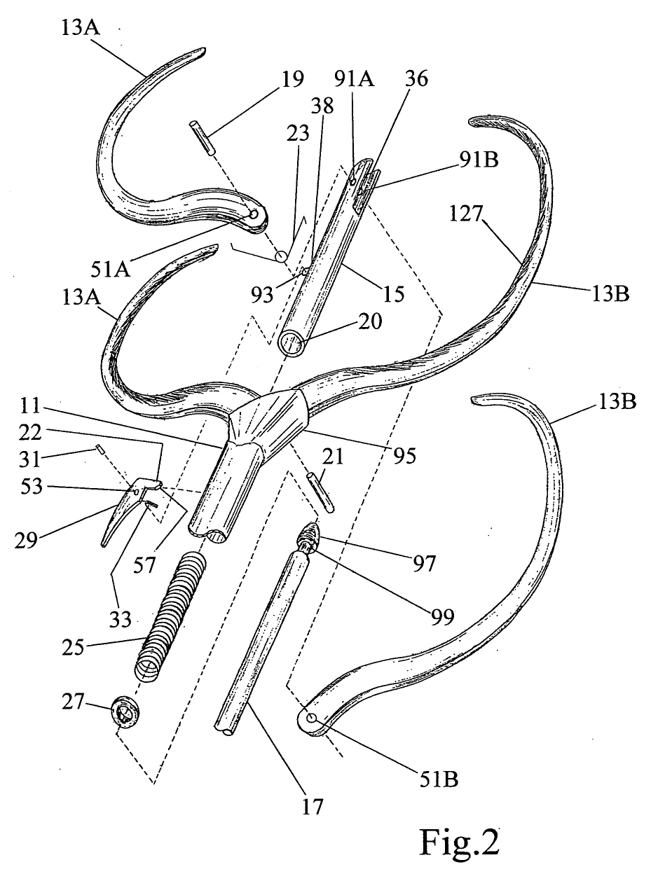

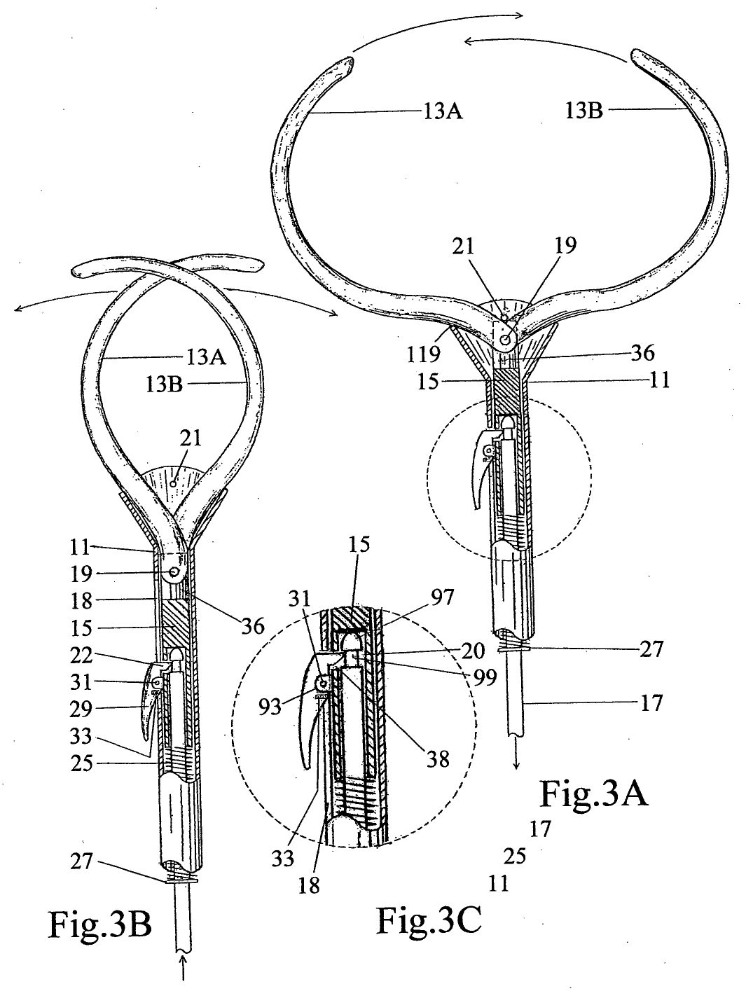

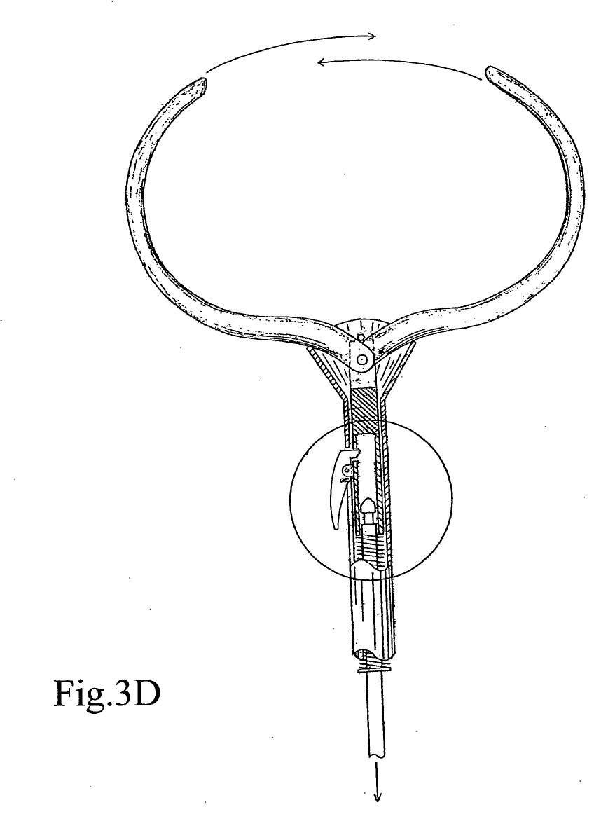

The front part of body 11 houses carriage 15 as shown in FIG. 2. All moving parts are in one way or another connected to carriage 15. Carriage 15 is cylindrical shaped with a hollow base 20 large enough and deep enough for carriage extension 17 (which will be referred to as extension 17) to slide longitudinally inside. The front solid part of carriage 15 has a slit 36, and two openings 91A and 91B perpendicular to slit 36. A plurality of talon-like appendages 13A and B (which will be referred to as talons) that have openings 51A and B at the back ends align with openings on carriage 91A and B, and are pivotally attached with fastener 19. Talons are curved appendages large enough and strong enough to grasp and hold an adult human being. They can also have a soft material 127 adhered to the inside ends to prevent injury to people being rescued. (FIG. 2) They are disposed in front of the mechanism facing each other curving inwards. Flair 95 has a lug 21 perpendicularly displaced between the talons 13A and B to limit the forward axial movement of carrier 15 as shown in FIG. 3A. A torsion spring 23 (FIG. 2) is located between talons 13A and B circling fastener 19 urges them to the open position. Carriage 15 also has a pair of parallel spaced apart flanges 93 radially projecting from carriage 15 which allow the release latch tab 29 disposed within the clearance of flanges 93 free movement as it is pivotally displaced about a fastener 31 that passes through aligned openings on both spaced apart flanges 93 and release latch tab 29. Release latch 29 has a sear 22 with a beveled edge 57 extending through a slot 38 on carriage 15 into its hollow base 20. (FIGS. 2, 3A, B, C) A coiled spring 33 urges release latch 29 to the latched position. Carriage 15 is being urged forward by a coiled spring 25 displaced longitudinally around extension 17. Coiled spring 25 is being held in place by annulus retainer 27 which is attached to the inside of body 11. Extension 17 is tubular shaped with a solid front end, a conical shaped tip 97 and a groove 99 disposed around its axis behind the conical tip 97. FIG. 3C

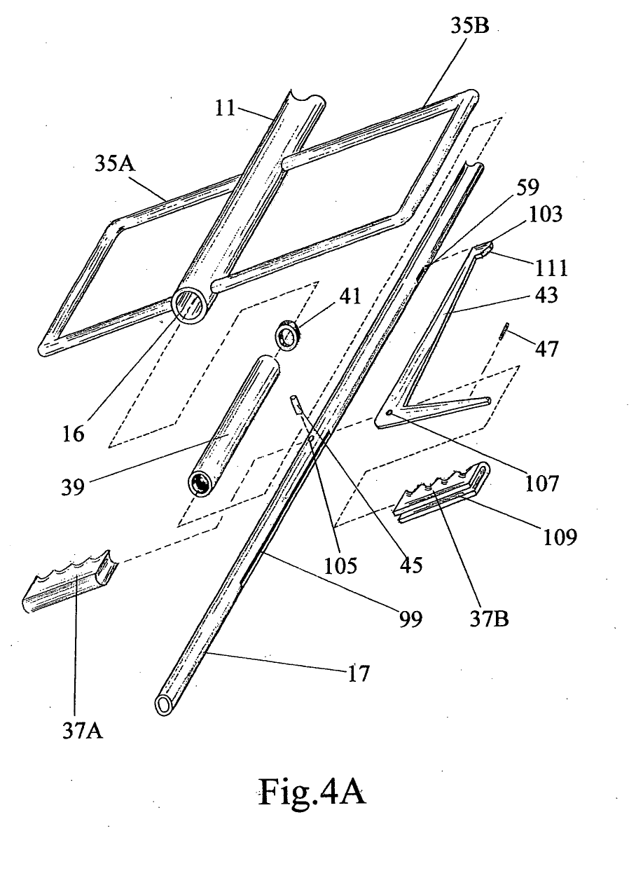

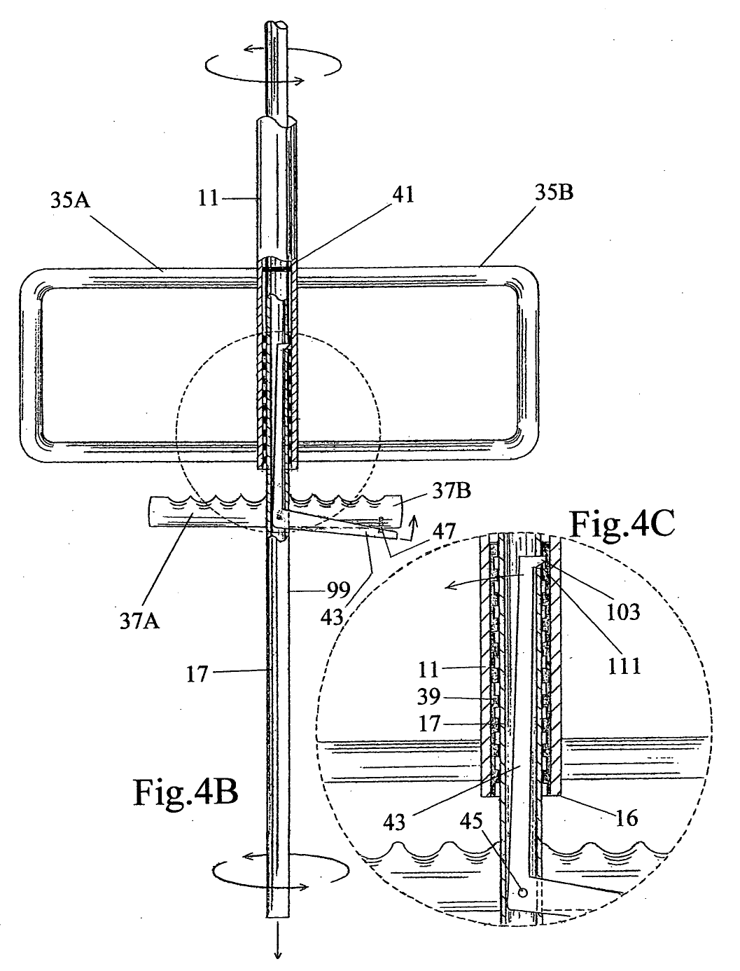

The front of extension 17 slides inside hollow base 20 of carriage 15. (FIGS. 3A, B, C) Extension 17 is located along the center of body 11 supported by carriage 15 in front and a grooved sleeve 39 at breech end 16 as shown in FIG. 4A and FIG. 4B. Sleeve 39, which has a series of circular grooves along its axes on the inside, is attached to the back end of body 16 shown in FIGS. 4B and 4C. Extension 17 passes through grooved sleeve 39 before exiting the rear of body 16. The exposed part of extension 17 has a plurality of radially attached handles 37A and B that allow the manipulation of extension 17 along its axis. Extension 17 can be rotated 360 degrees on its axis without effecting the operation of the mechanism as shown in FIG. 4B. It also has a groove 99 FIG. 4A extending along its axis that allows the front part of locking latch 43 to be disposed inside of extension 17 as shown in FIGS. 4A and B. Extension 17 has openings 105 which align with opening on locking latch 107 and are pivotally secured by fastener 45. FIG. 4A Locking latch 43 has sear 103 with bevel 111 at the front end that protrudes radially through slot 59 on extension 17 and engages the grooves on locking sleeve 39 as shown in FIGS. 4A and C. The back part of locking latch 43 radially extends out of extension 17 and is disposed within the clearance of a groove 109 located radially along one of the extension handles 37B as shown in FIG. 4B. Coil spring 47 located inside extension handle 37B urges locking latch 43 to the locked position.

### OPERATION

### FIGS. 3A, 3B, 3D, 4A, 4B, 4C

The normal position of the preferred embodiment is with talons 13A and B in the open position, and sear on release latch 22 on the latched position as shown in FIG. 3A. This position mechanically connects talons 13A and B to the handles 37A and B at the back of extension 17. When handle or handles 37A and B are manipulated back, bevel 111 on sear 103 of locking latch 43 acts as a ratchet locking its way on grooves of locking sleeve 39 as extension 17 moves along the axes of body 11 as seen on FIG. 4C. As extension 17 moves back, sear 22 on release latch 29, which is engaged on groove of extension 99, pulls carriage 15 back. The back sides of talons 13A and B which are pivotally attached to carriage 15 are pulled back along the axes of the body as seen on FIG. 3A. As talons 13A and B are pulled back, the outer edges which are contiguous with the flared end of body 119, FIG. 3A force talons 13A and B to close as shown on FIG. 3B. Talons 13 A and B will remain on the locked position until release latch 29 is pressed, which will disengage sear 22 from extension 17 FIG. 3D. Carriage return spring 25 will push carriage 15 forward. As it moves forward, torsion spring 23 will open talons 13A and B, which were being held in the closed position by flair 95 as shown in FIG. 3D. To reset the mechanism, the exposed end of locking latch 43, located at the back of one of the handles of extension 17, (FIG. 4B) is pushed forward. This will disengage sear 103. Extension 17 is then manipulated forward, which will urge the conical shaped tip of extension 97 to pivot release sear 22 on release latch 29 and reset sear on extension groove 99, connecting handles of extension 37A and B once again to talons 13A and B as shown in FIG. 3C.

### ADDITIONAL EMBODIMENTS

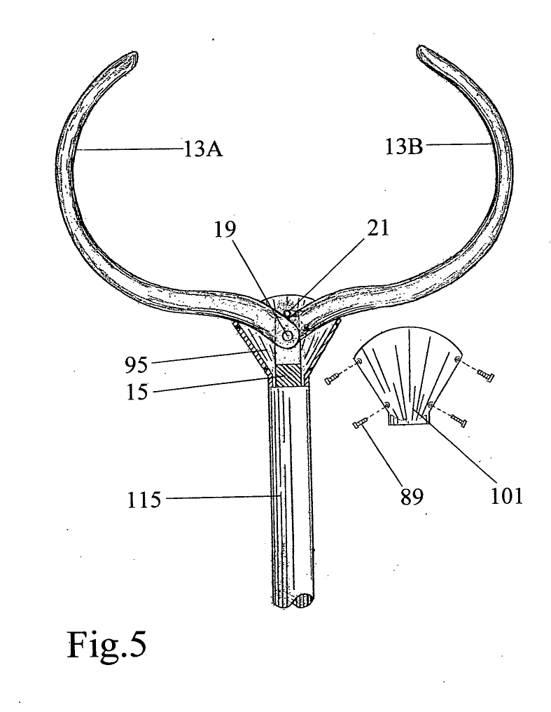

### FIGS. 5, 6, 6b, 7a, 7b, 8, 9, 10

If it is desired to have easier access to the internal parts of the device, another embodiment discloses a two-piece flair, FIG. 5. Four fastening screws 89 attach a removable lid 101 displaced over the top part of flare 95 as seen on FIG. 5. The removal of lid 101 allows easy access to the internal moving parts of another embodiment.

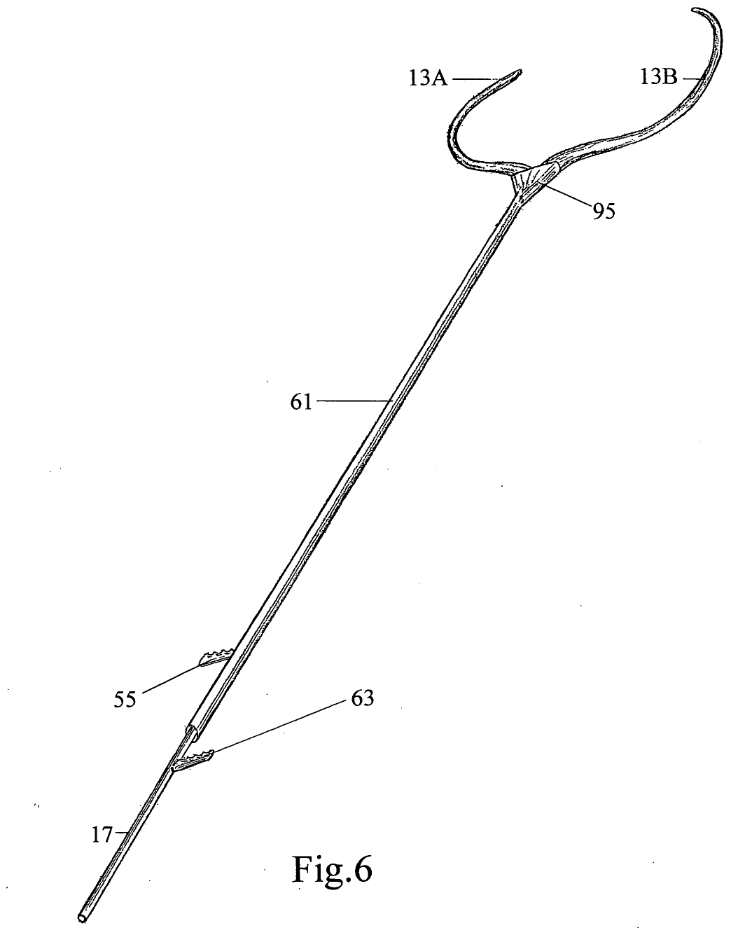

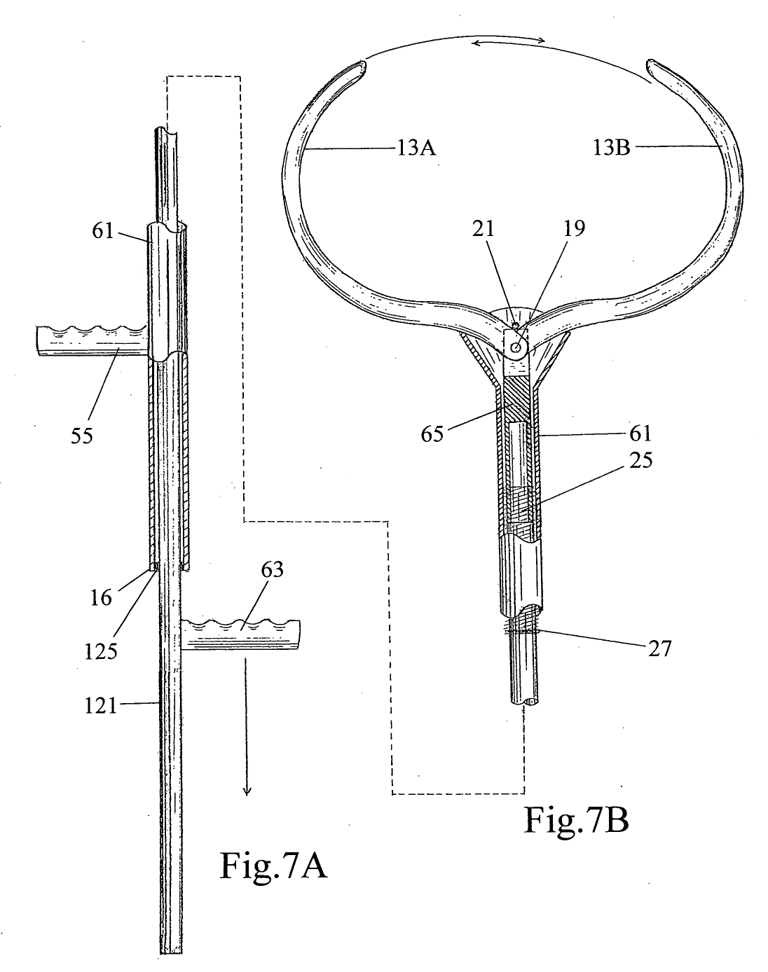

FIG. 6 discloses a perspective view of a similar embodiment excluding locking and unlocking mechanisms. It comprises a tubular body 61 of a predetermined length and diameter with a flare 95 at the front end extending away from body in opposite directions at a predetermined angle and length. The back end of body 61 discloses a handle 55 extending radially at a predetermined distance from breech. Body 61 houses a carriage 65 (FIG. 7B), that has a cylindrical solid front and a tubular rear disposed inside along the axes of body 61, protruding at the breech where it is supported by sleeve 125 attached to breech of body 61 as seen in FIG. 7A. The method used to attach talons 13A and B to carriage 65 is the similar to the preferred embodiment, FIGS. 3A, 3B and 7B. The back ends of talons 13A and B slide inside slit 36 in front of carriage 65. Talons 13A and B are pivotally displaced with a fastener 19 positioned through the aligned perpendicular openings on talons 13A and B and carriage 65. Talons 13A and B are being urged to the open position by torsion spring 23 displaced between talons 13A and B and surrounding fastener 19. Carriage 65 is being urged forward along its axis by coiled spring 25 displaced longitudinally surrounding carriage 65. Annulus retainer 27 attached to the inside of body 61 holds spring 25 in place. A perpendicularly displaced lug 21 in front of flare 95 limits the forward axial movement of carriage 65. Breech end of carriage 121 comprises single handle 63 extending radially at a predetermined distance from the breech of carriage 121.

The normal position of similar embodiment is with talons 13A and B in the open position. To operate the similar embodiment, handle 63 at the rear end of carriage 121 is axially manipulated backwards. The front of carriage 65 will pull back ends talons 13A and B along the axis of body 61. As talons 13A and B move back, the outer edges which are contiguous to the flared part of body 61, urge then to close. To reset the mechanism, handle 63 at the breech end of carriage 65 is manipulated forward. As carriage 65 moves forward, talons 13A and B are moved forward. As flare allows, talons 13A and B are urged to the open position by the torsion spring 23.

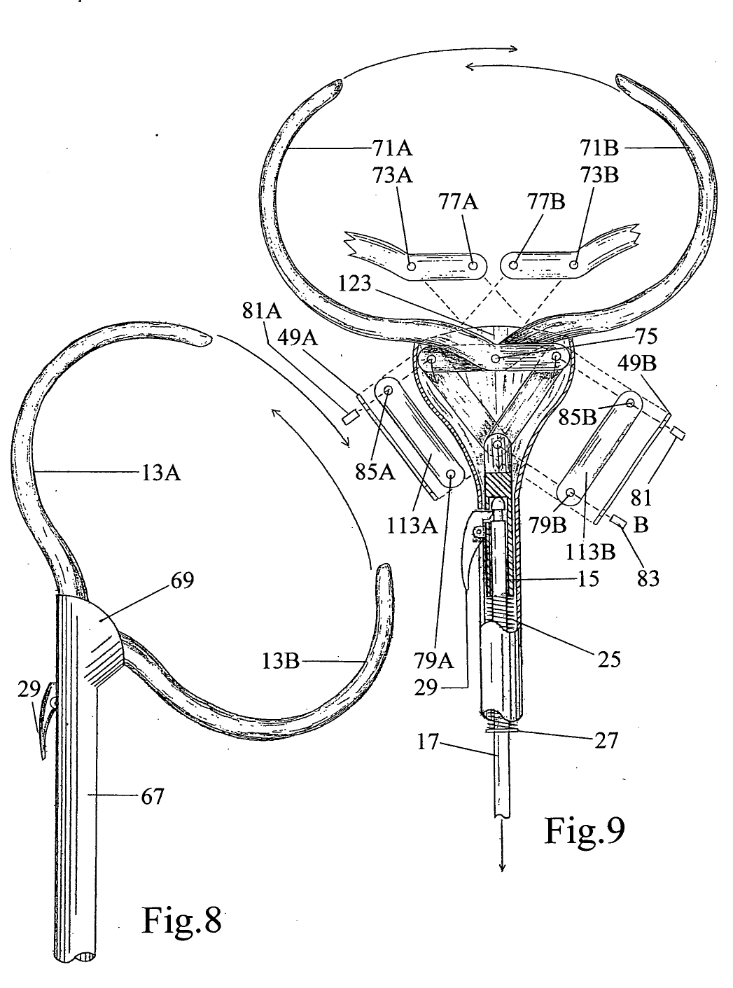

FIGS. 8, 9, 10 disclose other embodiments. The differences of the other embodiments are in the talons. A different embodiment is disclosed on FIG. 8. The uniqueness of this embodiment is on the way talons 13A and B are displaced. The direction of the flare 69 is angled at predetermined degrees to the side, thereby disposing talons 13A and B at an oblique direction. The manipulation and movement of this embodiment is the same as the preferred.

Talons 13A and B can be attached to the embodiment in a plurality of ways. The fifth embodiment shown in FIG. 9 is similar to the preferred. The differences are in the way talons 71A and B are attached to carriage 15. FIG. 9 discloses one of the ways. This embodiment also has enlarged body flare 123 to house the new apparatus. The back end of talons 71A and B extend a predetermined distance from the pivot openings 73A and B. A second opening is displaced at the end of the talons 77A and B. Talons 71A and B are pivotally displaced on flare of body 123 with fastener 75. The openings at the end of talons 77A and B connect to strap links 113A and B which have pivot openings on both ends (85 and 79). End openings on talons 77A and B align with openings on strap links 85A and B and pivotally secured with fasteners 81A and B. The openings at the back side of strap links 79A and B slide inside slit 36 at the tip of carriage 15 and align with openings on slit 91A and B and are pivotally secured with fastener 83.

The normal position of the talons is in the open position. To close the talons 71A and B, carriage extension 17 is manipulated backwards along its axis which will pull carriage 15 backwards. Carriage 15 will pull strap links 113A and B back, which will pull the ends of talons 77A and B back, pivoting talons on fastener 75. This will close talons in a scissor-like motion. To open talons 71A and B, carriage extension 17 is pushed forward, or release latch 29 is disengaged. Return spring 25 will push carriage 15 forward opening the talons 71A and B in a scissor—like motion.

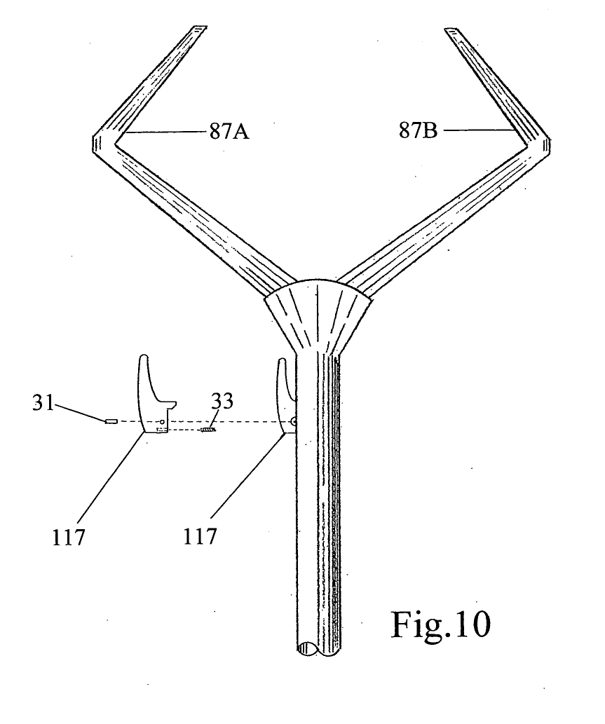

Talons 13A and B can be in a plurality of shapes. FIG. 10 discloses still another embodiment with talons 87A and B which are angled instead of curved. This embodiment also makes use of a different release latch 117 designed to release when lifted.

### CONCLUSION, RAMIFICATIONS AND SCOPE

Thus the reader will see that at least one embodiment of the lifesaving talons provides a much needed and desired device that can be used by almost anyone in various situations to save the life of another individual. It can also be used by firemen or policemen in many ways. There is a plurality of uses for the lifesaving talons, especially with the different variations in the design. The shape and angle of the talons, along with the length of the body, will depend on the need, whether it's pulling a person out from the bottom of a pool or moving a hazardous container to a safer place. The various ways that the talons can be attached to the carriage also depends on what it will be used for. For example, the talons that have a scissor-like movement will provide a different grip on whatever they grab. Maintenance of the device would be easy with the removable cover which allows access to the main parts. It can also be made without any locking mechanisms if they are not needed or desired. The material it is made of will depend on what it will be used for. Some examples of materials are stainless steel, titanium, fiber glass, and several of the strong, non conductive materials available. It is a device that will give people peace of mind to have around in case they need it.

While the above descriptions contain many specificities, these should not be construed as limitations on the scope of any embodiment, but as exemplifications of the presently preferred embodiments thereof. Many other ramifications and variations are possible within the teachings of the various embodiments.

Thus the scope of the invention should be determined by the appended claims and their legal equivalents, and not by the examples given.

I claim:

1. A life saving device used to aid in rescuing a person in peril, the improvement comprising;

2. The life saving device of claim 1 wherein body is elongated.

3. The life saving device of claim 1 wherein said body has a plurality of Talon—like appendages attached to one end.

4. The life saving device of claim 1 wherein said body has a plurality of handles attached to the opposite end.

5. The life saving device of claim 1 wherein said handles having means to convey radial energy to said appendages, whereby urging said appendages to open or close.
